(19) United States
(12) Patent Application Publication
(10) Pub. No.: US 2006/0074718 A1
(43) Pub. Date: Apr. 6, 2006

(54) Portable veterinary medical record apparatus and method of use

(75) Inventors: Ronald J. Fucci, South Portland, ME (US); Andrew W. Beardow, Portland, ME (US)

Correspondence Address: McDonnell Boehnen Hulbert & Berghoff LLP;31st Floor, 300 S. Wacker Drive, Chicago, IL, 60606, US

(73) Assignee: IDEXX Laboratories, Inc., Westbrook, ME (US)

(21) Appl. No.: 10/849,674

(22) Filed: May 20, 2004

(51) Int. Cl. G06F 19/00

(52) U.S. Cl. 705/3; 707/9

(57) ABSTRACT

An embodiment of a portable veterinary medical record system includes a portable memory storage device that contains both a data structure for medical records and a set of processing instructions related to use of the device. The set of instructions may include authentication instructions for user authentication; instructions for data storage; instructions for updating medical record information; instructions for recognizing host veterinary patient information management software; and instructions for displaying medical record information, for example. According to the embodiment, the set of instructions are automatically executed by a computer that couples with the device. An embodiment provides for authentication cards and authentication PINs to facilitate double-key authentication. The device may be retained by an animal owner. Such retention makes records more readily available in an emergency or during travel. In addition, owner retention of the device represents a practical acknowledgement of veterinary medical record co-ownership.

### BACKGROUND

1. Field of Invention

The present invention relates generally to electronic veterinary data systems and more specifically to portable veterinary medical record systems.

2. Related Art

Animals have an increasing importance to the everyday life for many people. Household pets, such as cats and dogs, for example, are prevalent. In addition, animal keeping and breeding may be pursued as a business. As such, animals are expensive and are commonly bought and sold for hundreds of dollars. Care for animals, including veterinary care, is quite important, and is sought out by animal owners.

Veterinary records are routinely kept at a veterinary office, and may provide details of office visits including vital statistics, symptoms, suspected diagnosis, treatment, billing, and accompanying notes. Although the veterinary records may be prepared by a veterinarian, a joint ownership persists in the records (and accompanying information) between the veterinarian (who creates the record) and the animal's owner. This co-ownership is reflected by statutes in many localities that require a veterinarian to provide access to veterinary records to owners after receiving a proper request. Despite the legal requirement, no strong technological means has been implemented for ensuring compliance, or for providing joint record access.

### SUMMARY

As a response to the aforementioned veterinary medical record problems, the present invention provides for various embodiments of a veterinary medical record apparatus and methods of operation. An embodiment provides for a portable (handheld) veterinary medical record device that is retained by an animal's owner. During a visit to the veterinary office, data may be synchronized with a patient information management system (PIMS) or may be stored directly on the device. Firmware stored locally on the portable device ensures proper user authentication (e.g. proper owner and veterinarian identification) and also controls aspects of veterinary medical record management.

Because the device is retained by the owner, records may be more readily available in the case of an emergency or during travel. In addition, owner retention of the device represents a practical acknowledgement of veterinary medical record co-ownership. Thus, an owner may be able to examine medical records of the animal even when outside the veterinary office. According to aspects of one embodiment, updates may be restricted to take place only at a veterinary office to avoid mistakes that may be commonly made by non-professionals attempting to practice veterinary medicine. In another embodiment, however, certain updates to animal records may be made outside of the veterinary office.

According to an embodiment, a portable veterinary medical record device has a nonvolatile re-writable memory array (such as a flash-memory) configured within the device. A data structure is organized on the re-writable memory array for storing veterinary records. The data structure may be configured as a database or other organized body of related information, for example.

In order to properly control the co-ownership of veterinary medical records, a first set of machine readable instructions (such as firmware) may be stored in the re-writable memory for providing user authentication. Thus, according to the preferred embodiment, veterinary records in the data structure are inaccessible without proper authentication.

In the embodiments, user authentication may take several forms including, for example, an owner authentication card; an owner identification personal identification number (PIN); a veterinary authentication card; a veterinary PIN; a veterinary license number; a software license number, etc. The device may also include a set of authentication values stored on a nonvolatile read-only portion of the device and are used as keys for ensuring proper authentication. User authentication may also include two security levels. For example, in one embodiment, a first security level provides read-only access to the veterinary records while a second security level provides read and write access.

A data port on the device is useful for communicatively coupling the memory to a computing device (such as a computer or PDA). According to an embodiment, the data port is a serial port such as a Universal Serial Bus (USB) port. Other data ports are available.

In a further (or alternative) embodiment, firmware is provided on the memory that is configured for automatic execution by a computer coupled to the portable device. The automatic execution may, for example, be triggered by coupling the portable device with the computer. In one embodiment, the firmware determines whether patient management software is installed on the computing device, and, in response to the determination may execute a second firmware for providing access to the veterinary records.

In yet another embodiment, a portable medical record apparatus includes a portable record-holder; a veterinary authentication card; and an owner authentication card. Medical records are stored on the portable record-holder while the authentication cards are provided for user (veterinarian and owner) identification. The portable record-holder has a data port for coupling with a computer and two authentication ports for coupling with the authentication cards. Various levels of access may be provided to the medical records depending upon the amount and type of authorization supplied.

According to a method of operation of an embodiment, veterinary records are accessed at a computer that can be coupled with a portable memory element. In the method, coupling the portable memory element with the computer serves as a trigger for the computer to execute a first set of instructions stored on the portable memory element. Executing the first set of instructions enables the computer to determine whether a given patient information management software (PIMS) is installed on the computer.

If the given PIMS is installed on the computer, then access of the veterinary records may allowed through the PIMS. Alternatively, if the given PIMS is not found to be installed on the computer, then access to the veterinary records may be provided through a second set of instructions stored on the portable memory device that are executable by the computer.

### BRIEF DESCRIPTION OF THE DRAWINGS

FIG. 1 is a block diagram showing a portable veterinary medical record device coupled with a computer.

FIG. 2(a) is a block diagram of an embodiment of a portable veterinary medical record device.

FIG. 2(b) is a block diagram of another embodiment of a portable veterinary medical record device.

FIG. 2(c) is a block diagram of yet another embodiment of a simplified portable veterinary medical record device.

FIG. 3 is a three-dimensional diagram of a simplified embodiment of a casing of a portable veterinary medical record device.

FIG. 4 is a block diagram of an embodiment of a portable veterinary medical record device coupled various elements such as a computer and authentication cards.

FIG. 5 is an isometric diagram of an embodiment of a handheld portable computer coupled with a veterinary medical record device.

FIG. 6(a) shows an embodiment of a veterinary record data structure.

FIG. 7(a) shows a process flow diagram of an operation of an embodiment for providing access to veterinary data that is stored on a portable veterinary medical record device.

FIG. 7(b) shows another process flow diagram of an operation of an embodiment for providing access to veterinary data that is stored on a portable veterinary medical record device, and may serve as a continuation of the process flow of FIG. 7(a).

### DETAILED DESCRIPTION

1. Overview

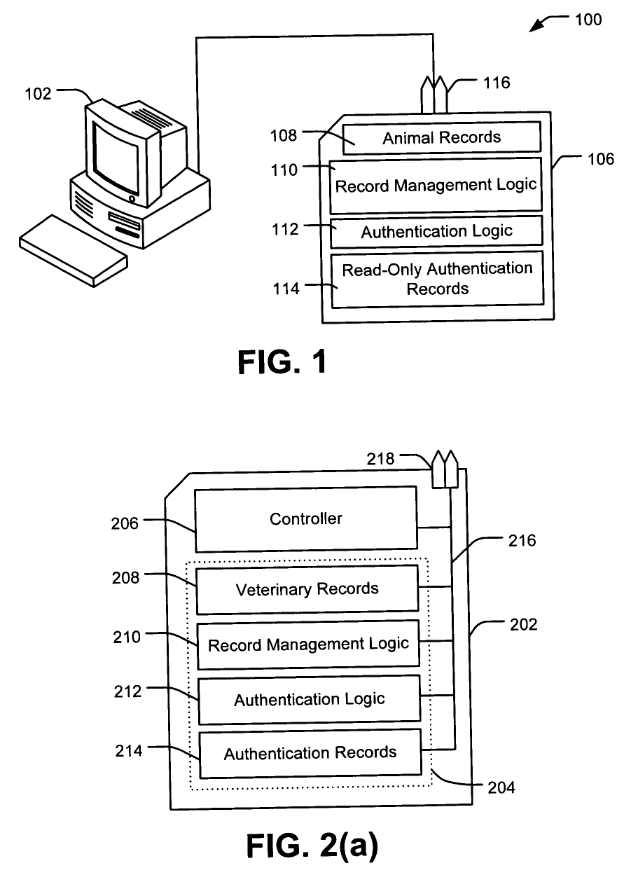

Focusing now on the drawings, FIG. 1 provides a block diagram showing a portable veterinary medical record device 104 communicatively coupled with a computer 102, and is a simplified overview of an embodiment of a veterinary medical record system and a method of operation. The veterinary record device may be configured to hold veterinary records and other information for a single animal or may be configured for multiple animals.

The veterinary record device 104 stores data on a nonvolatile memory array. The nonvolatile memory array may, for example, be a flash memory element or other EPROM. Additionally, some data storage is provided on the device 104 for providing read-only data storage. A data structure 106 is stored on the nonvolatile memory array for storing veterinary medical records. The data structure 106 may, for example, be a flat file containing data. Alternatively, the data structure 106 may be a database or other data structure.

Authentication logic 108 provides a set of instructions that may be executed by the computer 102 for requesting and evaluating user authorization codes that ensure privacy of the data structure 106. According to an embodiment, the data structure 106 is inaccessible unless proper user authentication is determined using the authorization logic 108. The authentication logic 108 may be stored in either re-writeable memory or read-only memory.

Record management logic 110 is also executable by the computer 102 and enables the computer 102 to access records in the data structure 106. Access may include, reading records, updating records, deleting records, and inserting new records, for example.

Authorization values 112 are stored in read-only form on the medical record device 104. These values are used as keys by the authentication logic 108 to determine whether proper user authentication has been provided. According to an embodiment, the authorization logic 108 provides a method for determining whether proper user authentication has been provided without revealing the authentication values 112.

Below the system diagram of FIG. 1, a messaging diagram provides a simplified overview of a method of operation of the veterinary medical record system. In particular, a method is shown for providing access at the computer 102 to veterinary medical records stored at the portable memory element 104. Initially, the computer 102 is communicatively coupled with the portable memory element 104 at step 150. This coupling may, for example, be carried out by joining a male portion of a USB connection of the portable memory element 104 with a female portion of a USB connection of the computer 102. Other connections are also available.

Once in communication, the computer 102 may execute the authentication logic 108 at step 152. According to an embodiment, step 152 is executed automatically (autorun) and is triggered by the coupling step of 150. As part of the authentication logic, authentication inputs are requested from a user at step 154. These authentication inputs may, for example, be an owner's PIN.

In order to determine whether the authentication inputs are correct, a query is placed to the authentication values 112 of the portable memory element 104 at step 156. The query may be configured to query whether a particular PIN is an authorized PIN. In that case, the authorization values 112 do not need to be revealed during the authorization process.

If proper user authorization exists, the computer executes the record management logic 110 at step 158. According to an embodiment, various levels of proper authorization are possible. Thus, different aspects of the record management logic 110 may be executed depending upon the level of user authorization.

In the embodiment shown, sufficient user authorization has been provided in order to allow for updating of the veterinary records. Thus, steps 160-164 provide for an interaction between the computer 102 and the data structure 106 that results in an updated record. In step 160, the computer 102 requests a record from the data structure 106. The request may, for example, be triggered by a computer user (such as a veterinary office employee) who is prepared to update a medical record that had been partially completed. At step 162, the requested record is provided to the computer 102 by the data structure 106. And, at step 164, the computer 102 delivers an updated record to the data structure 106 for incorporation.

Other methods of operation provide for automatically updating or synchronizing records, viewing records, interoperating with a patient information management system (PIMS), first time setup, etc., for example.

2. Exemplary Portable Memory Device

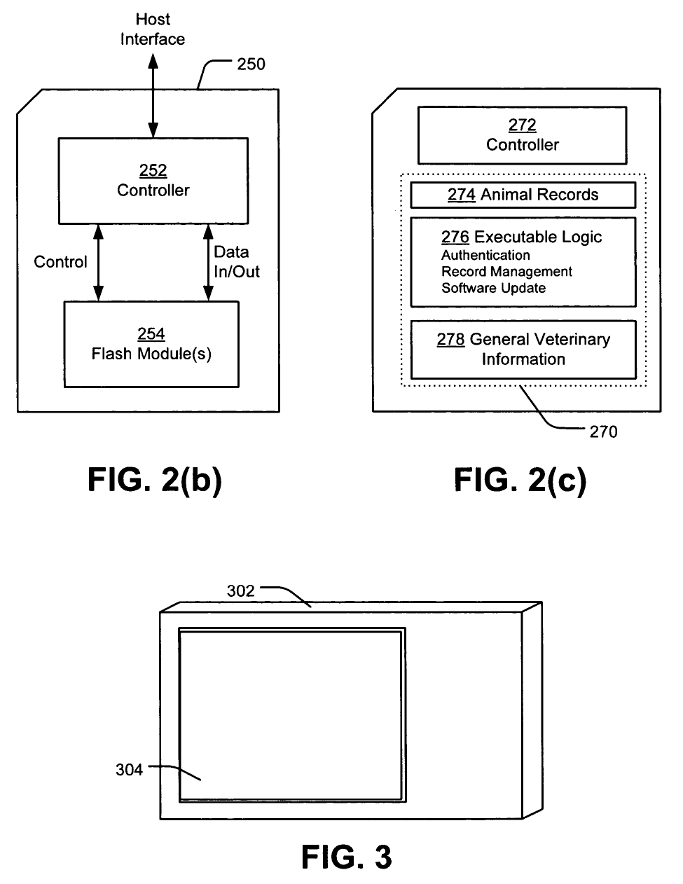

FIG. 2(a) provides a block diagram of an exemplary embodiment of a portable memory device 202. According to the exemplary embodiment, the portable device 202 is a handheld element that fits in a human hand. However, depending upon implementation details, the shape and size of the portable device 202 may be altered.

At least one memory array 204 is configured as part of the portable device 202 for data storage and is shown as a dashed rectangle for convenience. The memory array 204 may, for example, be a Flash-memory or other EEPROM. Alternatively, the memory array may be a mini hard-disk, magnetic memory (such as MRAM), or other portable electronic storage device.

According to an embodiment, the Flash memory is a nonvolatile memory using NOR gates, which allows the user to electrically program and erase information. Flash memory uses memory cells similar to an EPROM, but generally has a thinner, more precisely grown oxide between a floating gate and a source. Flash programming occurs when electrons are placed on the floating gate. The charge is stored on the floating gate, with the oxide layer allowing the cell to be electrically erased through the source.

In addition to being a form of non-volatile memory, it may be advantageous to provide other data protection schemes to ensure that the data on the device is stable. This is especially if, for example, an owner intends to always carry the device 202 on-person.

A data protection scheme of one embodiment is dynamic hardware block-locking that secures critical code while non-locked blocks are programmed and erased. This locking scheme offers two levels of protection. The first level allows software-only control of block-locking (this is useful for frequently-changed data blocks); while the second requires hardware interaction before locking can be changed (to protect infrequently-changed blocks). Other (or additional) data protection schemes are also available and can by applied by one skilled in the art.

The memory array 204 may be divided into at least two parts. (Not shown). This division may be either a physical separation or a logical separation and represents a separation between read-only portions and portions that may allow both read and write operations. As an example, the memory array 204 may have an asymmetrically-blocked memory layout to enable a small parameter or boot code storage that is left as read-only and larger blocks for other code and veterinary record storage. Alternatively, the memory array 204 may be symmetrically-blocked to enable better code and data file management. Other arrangements are available—such as multiple arrays with various properties.

A controller 206 is provided for controlling programming and erasing of information stored on the memory array 204. The controller 206 may, for example, manage interface protocols, data storage, data retrieval, error correcting code (ECC), defect handling, diagnostics, power management, and clock control. A bus 216 couples the controller 206 with the memory array and with a data port 218.

Programming of the memory of the exemplary embodiment may be done in a byte or word-wide mode. However, a larger buffer—such a 32-byte write buffer may be provided for more rapid bulk writing. Such a buffer allows data to be queued in advance for more effective byte programming speeds. Erasure of a flash memory is done through a block erase command, and the completion time is dependent upon the block size and implementation. Other functions may be available such as program-suspend, program-resume; erase-suspend, and erase-resume. These functions allow the device to pause and read data, and then resume the pervious operation. A multi-partition architecture may allow the system processor to read from one partition while completing a write/erase in another partition. For example, this permits executing code and storing veterinary records from the same memory array 204 at the same time.

Several virtual information modules are shown within the memory array 204. For example, a data structure holding veterinary records 208 is provided. The data structure 208 may, for example be a database file (or set of files) stored as re-writable memory.

Management of the veterinary records 208 is controlled by instructions set forth in the record management logic 210. The logic may, for example, be a set of machine readable instructions that may be executed (or run) by a processor coupled to the device 202 at the data port 218. In another embodiment, the record management logic 210 is a form of firmware.

Firmware may, for example, be defined as software that is embedded in a hardware device that allows reading and executing the software, but does not allow modification, e.g., writing or deleting by an end user. Firmware may, however, allow for periodic updates. Different firmware modules may be integrated into a single module—however because the new module still performs functions of both previous modules, it may still logically be known as two modules.

According to various embodiments firmware may be installed at a factory setting, at a veterinary office, or at an owner's computer, for example. Portions of firmware may be installed at different locations and different times depending upon user needs.

According to this embodiment, the record management logic is generally stable, and left unchanged by user interaction. However, the embodiment allows for firmware updates that may be periodic or occasional.

According to an embodiment, access to the veterinary records 208 is restricted without proper authentication. Authentication logic 212 is stored on the memory array 204 and may be stored in either read-only memory or re-writable memory. The authentication logic 212 should not, however, be rewritten through user interaction—lest access to the veterinary data may be lost. The authentication logic 212 may also be, for example, a set of machine readable instructions executable by a processor coupled to the device 202. Likewise, the authentication logic may be termed firmware. Upon execution, the authentication logic 212 is configured to allow a determination as to whether there is proper user authentication.

Authentication values 214 may serve as keys during execution of the authentication logic 212. For example, the authentication logic may check an entered owner personal identification number (PIN) against key stored in the authentication values 214.

The authentication values 214 should be stored in read-only memory and access the keys limited to prevent unauthorized access to the veterinary records 208.

According to one embodiment, the authentication values are stored in one time programmable (OTP) registers on the memory array 204. For example, two 64 bit OTP protection registers may be provided on a Flash memory device. OTP registers are useful for increasing system security by programming a unique, unchangeable 64-bit number into the OTP, and the other OTP may be programmed during use as desired. Once programmed, the customer segment can be locked to prevent further reprogramming. The OTP information can be used as a small-encrypted security key for system authentication. Other forms of hard-coded secure memory are available.

An alternative organization of a portable veterinary medical record memory device is provided in FIG. 2(b) as a block diagram showing logical communication pathways. The memory device 250 contains a controller 252 and a set of memory modules 254. Although Flash memory modules are shown as the memory modules 254, other types of memory are available.

According to the embodiment, the controller 252 communicates through a host interface with an external device such as a computer (not shown). In addition, the controller 252 controls the memory modules 254 and controls read/write operations of the memory modules 254.

Yet another embodiment of a portable veterinary medical record device is provided in FIG. 2(c) as a block diagram. A controller 272 is provided to control access to a memory element 270 (dashed box). The memory element 270 contains various types of data that are shown with a high-level description of their contents. For example, animal records 274 (preferably from a veterinary office) occupy a portion of the memory element 270. Three types of executable logic 276 are provided—although more are possible. User authentication logic ensures that proper user authorization is achieved prior to allowing access to the animal records 274. In one embodiment, the authorization logic continually operates to ensure proper authorization throughout a data access session. Record management logic provides, as an example, for reading and updating of the animal records 274.

Software update logic is configured to enable a computer that is coupled to the memory device to check for, download, and/or install updated software onto the memory device. This operation may, for example, require an Internet connection at the computer.

General veterinary information 278 may, for example, provide for formularies or disease information. In addition the general veterinary information 278 may provide reference material that an owner may use for information. Logic may also be included for updating this information either from a PIMS system or from the Internet. In addition, the general veterinary information may include links to Internet sourced information.

Several elements were provided at the memory element 270. According to various embodiments, any combination of the elements may be included in a memory device.

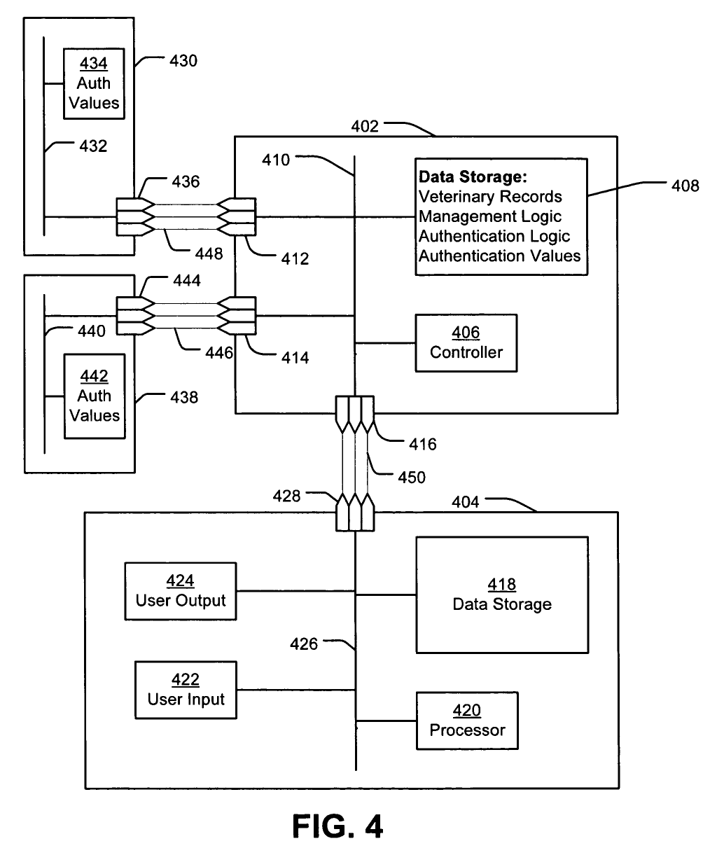

FIG. 3 provides a simplified three-dimensional view of a veterinary memory device 302 showing an immediate data access surface 304. According to an embodiment, the device 302 has a casing made of plastic or metal (or combination). The casing provides protection to the electronic elements within the device 302. According to another embodiment, a hole is provided in the device 302 to allow for a keychain to pass through the hole to secure the device 302 from loss or misplacement.
b. Embodiment Having Authentication Cards

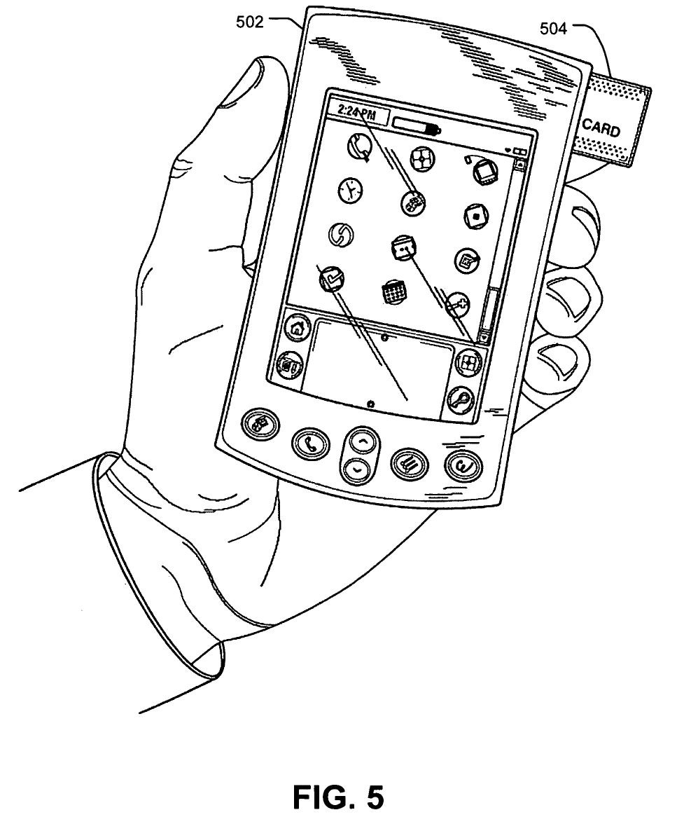

FIG. 4 provides an alternative embodiment of a portable veterinary memory device 402. According to this embodiment, additional ports are provided for coupling authentication cards (such as a veterinary authentication card or an owner authentication card) to provide a physical authentication key before allowing a user to access veterinary records stored on the device 402.

The memory device 402 may, for example, be a portable device having a controller 406 for controlling operation of data storage 408. The controller 406 and data storage 408 may be interconnected with a data bus 410 or through other means (such as a wire configuration or a wireless configuration, i.e., Bluetooth).

The data storage 408 is configured to hold various types of binary encoded data. For example, veterinary records, management logic, authentication logic, and authentication may all be stored in data storage 408. Other types of data may also be stored in data storage 408 depending upon its configuration. Data storage 408 may include a single memory array or multiple memory arrays. More generally, the data storage 408 may be any form of nonvolatile memory.

A data port 416 at the memory device 402 is also connected to the data bus 410 and is configured to provide access to a computing device. The data port 416 at the memory device 402 is shown coupling with a data port 428 at a computer 404. The connection between the two data ports 416 and 428 is through a connecting line 450 that may, for example, be a cable. In an alternative embodiment, the data ports 416 and 428 couple directly, or may allow for communicative coupling across a radiofrequency (RF) network.

The computer 404 has various elements such as a processor 420, data storage 418, a user input 422, a user output 424, and the data port 428. The elements are shown interconnected through a data bus 426, although other methods of interconnection are possible.

The user input 422 and the user output 424 may be typical user I/O devices of a computer such as a keyboard, mouse, speaker, display, etc. Other types of inputs and outputs are available as well. A purpose of the user input 422 and the user output 424 is to allow for computer-user interaction.

Depending upon the configuration of the computer 404, data storage 418 at the computer 404 may have a patient information management system (PIMS) installed that includes a database of veterinary medical records. In an alternative embodiment, no PIMS is installed on the data storage 418.

Again looking at the memory device 402: two additional ports may be provided for interaction with authentication cards. Both a first device authentication port 412 and a second device authentication port 414 are coupled to the data bus 410.

The first device authentication port 412 is shown communicatively coupling to a card port 436 at a veterinary authentication card 430 through, for example, a cable 448. Alternatively, the ports 436 and 412 may be directly or otherwise coupled.

The second device authentication port 414 is shown communicatively coupling to a card port 444 at an owner authentication card 438 through, for example, a cable 446. Alternatively, the ports 414 and 444 may be directly or otherwise coupled.

Although other embodiments are possible, the veterinary authentication card 430 is shown with a set of authentication values 434 stored in a nonvolatile read-only memory. A data line 432 interconnects the authentication values 434 with the card port 436. A controller (not shown) may also be included on the veterinary authentication card 430 for assisting in data-reads. According to an embodiment the authentication values 434 at the veterinary authentication card 430 provide keys to the authentication logic stored on the data storage 408 of the memory device 402 as physical means of authenticating veterinary identity.

In a parallel fashion, the owner authentication card 438 is shown with a set of authentication values 442 stored in a nonvolatile read-only memory. A data line 440 interconnects the authentication values 442 with the card port 444. A controller (not shown) may also be included on the owner authentication card 438 for assisting in data-reads. According to an embodiment the authentication values 442 at the owner authentication card 438 provide keys to the authentication logic stored on the data storage 408 of the memory device 402 as physical means of authentication of owner identity.

In addition to the physical authentication provided by the authentication cards 430 and 438, user authentication logic stored at the data storage 408 of the memory element 402 may require other user authentication codes such as owner and/or veterinary identification numbers that may be provided to the device at the user input 422.

Thus, according to an embodiment, the veterinary memory device 402 provides a portable means for storing and transporting veterinary medical records. In addition, the device provides an ability for an animal owner to retain practical rights that parallel legal rights. User authentication is provided for record privacy and control and may include both physical authentication and, for example, PIN numbers.

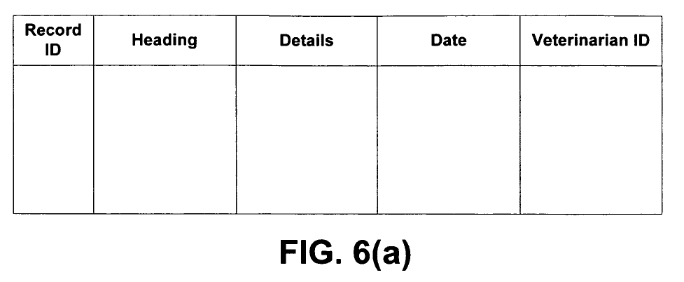

FIG. 5 provides an isometric view of another embodiment. A handheld computing device 502, such as a PDA or wireless device, has a slot for connecting a memory device 504. As shown, the memory device 504 is coupled to the computing device 504 at the slot. Thus, after proper authentication, veterinary medical records stored on the memory device 504 may be accessible at the computing device 504.

3. Universal Serial Bus (USB) Connector

Referring again to FIG. 1, the coupling between the computer 102 and the portable veterinary record device 106 may, for example, be a serial line such as a universal serial bus (USB).

USB is a standard port that enables connections between external devices (such as the veterinary medical record device) and computers (such as a PC or Macintosh). One USB standard supports data transfer rates of 12 million bits per second (Mbps). Another USB standard (USB 2.0) supports data transfer rates of 480 Mbps.

Many USB devices can work on either a Windows platform (i.e. Win 98, Win 2000 and Win XP), a Mac or other PC, provided the device manufacturer offers connectivity software for both computer systems. Many of the latest digital cameras offer USB as well as serial connections. Thus, USB connections provide a means for allowing computer-type portability.

Other means for providing computer-type portability are known to those skilled in the art and are also available. For example, the memory could be developed to be compatible with Personal Computer Memory Card Interface Association (PCMCIA) requirements. Numerous platforms and operation systems support the PCMCIA-ATA standard, including DOS, Windows®, Windows 95, OS/2, Apple System 7, UNIX, and many others.

Alternative connection devices are also available that may operate without loss of functionality. For example, a PCMCIA card or a Solid State Floppy Disk Card (SSFDC) have various types of connections available. Other connection types such as FireWire, Parallel, RF, Ethernet, Modem, or LAN may be alternatively used. One skilled in the art will recognize that the connection may be altered without reducing core functionality.

4. Auto Run

According to an embodiment, execution of firmware on a portable veterinary medical record device is triggered by an act of coupling the device with a computer. In certain computing systems, this functionality is referred to as an autorun function.

According to an embodiment, an Autorun.inf file is the primary instruction file associated with the Autorun function. The Autorun.inf file itself is a simple text-based configuration file that tells the operating system which executable to start, which icon to use, and which additional menu commands to make available. In other words, autorun.inf tells an operating system how to open the presentation and treat the contents of the memory device. Thus, according to the embodiment, the portable memory element is configured with an autorun.inf file stored in data storage on the element. The system is configured such that when the portable memory element is coupled with a computing device, a processor of the computing device executes the autorun.inf file.

The autorun sequence may be initiated when a disk change notification polling on the computing device discovers a new element attached to a USB port or otherwise discovers access to a new memory element. The computing device then checks in the new memory element's root directory for the existence of an autorun.inf file. If found, the computing device then reads and follows the instructions defined within the file. (I.e. executes the file).

If no autorun.inf file is found on the memory element then the computer may refer to the new memory element by its serial number and execute a default action associated with content on the element.

According to an embodiment, the autorun.inf file can define any combination of: 1) the process or application that will be automatically run when the memory is coupled with the computing device; 2) a process or application that will be selectively run depending upon specific operating environments; 3) an icon that can represent the memory element when the element is viewed as a drive on a display of the computing device; and 4) menu commands that may be displayed when a user “right-clicks” on the icon.

Shown here is a sample listing of an embodiment of an autorun.inf file that may be stored on a portable memory element:
1. [autorun]
2. open=filename.exe/argument1
3. icon=\foldername\filename.dll,5
4. [autorun.mips]
5. open=filenam2.exe
6. icon=filename.ico
7. [autorun.alpha]
8. open=filenam3.exe
9. icon=filename.ico
10. [autorun.ppc]
11. open=filenam4.exe
12. icon=filename.ico
13. shell\install=&Install
14. shell\install\command=setup.exe
15. shell\uninstall=&UnInstall
16. shell\uninstall\command=Uninstall.exe
17. shell\readme=&Read Me
18. shell\readme\command=notepad readme.txt
19. shell\help=&Help
20. shell\help\command=helpfilename.hlp

Table 1 provides further description of the autorun.inf file and each of the potential items shown in the listing:

TABLE 1

| Example Autorun File: | Description: |
|---|---|
| [autorun] | [autorun] is the primary, |
| | required section name. |
| open=filename.exe/argument1 | Open is the keyword to determine |
| | what action to take |
| | upon insert notification. |
| | filename.exe is the value defining |
| | the application that |
| | will be automatically started. |
| | /argument1 is the argument, |
| | parameter or switch passed to the |
| | application being run. Logically, |
| | any command line parameters used |
| | must be supported by the |
| | application. |
| icon=\foldername\filename.dll,5 | Icon is the keyword to determine |
| | the icon used for the disk. |
| | filename.dll is the value defining |
| | the file containing the icon. |
| | ,5 is the argument to the icon |
| | resource defining which |
| | icon to display. |
| [autorun.mips] | Defining the autorun items for a |
| | mips machine |
| open=filenam2.exe | The platform specific application |
| | to run |
| icon=filename2.ico | The platform specific autorun icon |
| [autorun.alpha] | Defining the autorun items for a |
| | DEC Alphamachine |
| open=filenam3.exe | The platform specific application |
| | to run |
| icon=filename3.ico | The platform specific autorun icon |
| [autorun.ppc] | Defining the autorun items for a |
| | Power PC |
| open=filenam4.exe | The platform specific application |
| | to run |
| icon=filename4.ico | The platform specific autorun icon |
| shell\install = &Install | The Keyword defining a menu item |
| | and the Hot key for that item |
| shell\install\command = setup.exe | The keyword defining the operation |
| | to perform when the user selects |
| | this item |
| shell\uninstall = &UnInstall | Additional menu item example |
| shell\uninstall\command = | Additional menu item example |
| Uninstall.exe | |
| shell\readme = &Read Me | Additional menu item example |
| shell\readme\command = notepad | Additional menu item example |
| readme.txt | |
| shell\help = &Help | Additional menu item example |
| shell\help\command = | Additional menu item example |
| helpfilename.hlp | |

On some computing devices, the autorun feature must be enabled prior to use. For example on a computer running Windows 95, Windows 98, or Window ME, the following listing provides a method for enabling/disabling autorun:
1. Access the System Properties Dialog. Using Control Panel: My Computer: Properties or Explorer: My Computer: Properties.
2. Select the Device Manager tab.
3. Select the USB DEVICE folder.
4. Select the entry for your USB DEVICE drive.
5. Select Properties.
6. Select the Settings tab.
7. Turn on or off the Auto insert notification option.
8. Select OK.
9. Select OK.

Alternatively, on a computer running Windows NT, or Windows 2000, the following listing provides a method for enabling/disabling autorun:
1. Start RegEdit (regedt32.exe).
2. Go to HKEY_LOCAL_MACHINE/System/CurrentControlSet/Services/USB.
3. Edit the Autorun value to ‘1’ to enable autorn, and ‘0’ to disable autorun.
4. Close RegEdit.

Other methods for enabling/disabling autorun are available for other computer systems as one skilled in the art will recognize. According to one embodiment, the computing device may require a restart before it will recognize a newly designated autoplay drive.

In certain computers, a storage device connected to the computer through integrated device electronics (IDE) or SCSI bus is considered a fixed drive, whereas a storage device communicatively coupled with the computer through a USB or IEEE 1394 bus would be regarded as removable by default. In addition, a storage device may have a media property that signifies whether media in the device is removable or fixed. According to the embodiment, the media property is set as removable in order to enable autorun. The listings provided above are merely for illustration and should not be seen as limiting to a particular sequence, terminology or type of listing. In other embodiments, no listing may be necessary. For example, a computer may be configured to execute a default file stored in a default location.

As an alternative to the autorun.inf file, software (or firmware) on the computing device may provide for functionality of determining how to react to a portable memory element being coupled with the computing device.

According to another embodiment, the portable memory element is configured to recognize that the computing device has a given PIMS installed. In this embodiment, the insertion of the portable memory element may trigger a registry reading or search of the registry to determine whether the given PIMS is installed. If the portable memory element is configured to operate with multiple PIMS, then multiple searches may be used.

In a further embodiment, a PIMS system is installed on the computing device. During installation, program information is placed in a registry on the computing device. Program information may, for example, comprise information such as a clinic ID, an activation key, release information, program directory, etc. Thus, according to one embodiment, the registry key is stored at HKEY_LOCAL_MACHINE\SOFTWARE\PIMS.

Once the portable memory element triggers a recognition that the given PIMS system is installed, direct access to PIMS data may be available through an ODBC data source that is installed on the computing device. Alternatively, the PIMS data may be accessible through an open API or through other means. The configuration of the data access will depend upon the nature of the given PIMS.

If an ODBC data source is used, a userID and password may be hard-coded into the data source to allow quick data access. Alternatively, other authentication may be required to access the PIMS data.

5. Smart Card

Another embodiment of a portable memory device involves the use of a credit card shaped plastic element with an embedded flash-memory chip. According to the embodiment, a plane electrode is connected to the flash-memory chip by bonding wires. The flash-memory chip, plane electrode, and bonding wires are each embedded in a resin using a technique known as over-molded thin package (OMTP). OMTP allows all the working elements of the memory to be integrated into a singe package without the need for soldering. According to the embodiment, the OMTP module is glued or otherwise affixed to a base card (plastic element) to create the physical device.

In operation, the card is inserted into a reading device (card reader) that supplies power and data through the plane electrode to the flash-memory chip. A notched corner of the card may be used to indicate power requirements of the card. For example, a notch on the left side may indicate a 5 volt card, while a notch on the right side may indicate a 3.3 volt card. In this embodiment, portions of the flash-memory chip can be erased, written to, or read in small blocks. For example 256 or 512 byte increments may be used.

In other embodiments, the portable memory device may include, for example, Flash memory, EEPROM, re-writable compact disk, floppy disk, portable hard-disk, etc.

Preferably, a portable memory device has nonvolatile memory. For example, in one embodiment, a Flash memory is provided with an operating shock rating of at least 2,000 G's. According to this embodiment, the more than 100 years can pass without loss or deterioration of data. In a further embodiment a built-in controller allow for defective chip cells to be mapped out, thus increasing chip yields.

6. Compatibility

Executable instructions may be provided in a language that is accessible to multiple types of computing systems. Alternatively, multiple instructions (one for each different type of computing system) may be provided on the portable device.

According to an embodiment, executable instructions are stored on the portable memory device. These instructions are configured to be executable without prior knowledge of the type of target hardware or software platform. For example, the instructions may be encoded in Java binary code format in order to produce instructions that are substantially architecture neutral. If a Java run-time system is made available on a given hardware and software platform, an application written in Java can then execute on that platform without the need to perform any special porting work for that application.

In this case, it may be appropriate to store machine language instructions in a form of bytecodes rather than traditional “machine code” or native hardware instructions. Bytecodes are essentially a higher level, machine-independent code that is implemented by the Java interpreter and run-time system.

7. Exemplary Data Structure

Veterinary medical records stored on a portable memory may provide, for example, a past medical history, test results, diagnoses, treatment plan, prescriptions, inoculation record, animal identification information, genetic information, allergies, billing history, veterinary notes, complaints, procedures, etc.

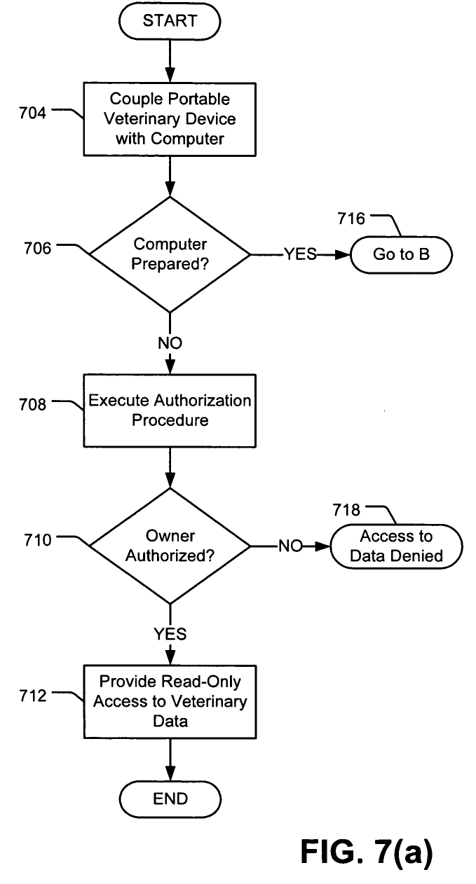

These records are preferably stored in a data structure such as data tables in a database. FIG. 6(a) shows a simplified data table structure for storing veterinary medical records. Five field headings are shown including a record identification number, record heading, record details, record date, and veterinary identification. Space is provided below the field headings for inserting new records. A record may be inserted, for example, to indicate that a heartworm treatment was given to an animal on a specific date by a veterinarian. This data table was provided as a limited overview and should not be seen as limiting to type, quantity, or organization of medical records stored on the portable memory.

According to another embodiment, the medial data is stored in a relational database structure having several data tables. It is contemplated that these tables may include Species, Exam Observations, Observations, Observation Types, Patient Diagnosis, Patient Visit Information, Diagnostic Codes, Examination Physical Exam Information, and Exam Observations. Table 2 provides a listing of these table names and potential fields that could be included within each table. One skilled in the art will recognize that the tables and fields may be altered.

TABLE 2

| Table Name | Possible Fields |
|---|---|
| Species: | Species ID; Species Description; Pounds, Ounces, |
| | Grams, Kilograms; Vaccine; Date vaccine expires; |
| | Years vaccine is good for; Vaccine type |
| | (K—Killed, M—MLV); Spayed/Neutered |
| Exam_{—} | Patient IDS; System ID - See table systems; |
| observations: | Observation Type |
| Observations: | Observation ID; System ID; Observation Type ID; |
| | Species ID; Text associated with observation; |
| | IDEXX Record Key; Last Modification Date |
| Observation_{—} | Observation type ID; Observation Type |
| types: | Description (Normal, Abnormal, Did Not Examine) |
| Pat_diag: | Patient ID; Diagnosis Date; Diagnosis ID; |
| | Diagnosis Sequence; Status (T—Tentative, |
| | F—Final); Date Final Diagnosis was made; |
| | Examination ID if Diagnosis was made through |
| | Exam room Module; Date diagnosis was ruled out |
| Patvlsit: | Client Identification; Patient Identification; |
| | Line Item; Invoice Item Identification; Invoice |
| | Item Sequence; Description (If Miscellaneous); |
| | Item Status (R—Recommend, A—Accept, |
| | P—Performed, D—Declined, |
| | H—Declined to History) |
| Diag_cod: | Unique code for diagnosis; Sequence for storing |
| | history of changes; PSI only descriptions for |
| | the VPI codes; Actual hospital's description |
| Exam: | Exam ID; Patient ID-see table patient; Date |
| | admitted; Date released; System template ID-see |
| | table system_templates; Exam comment; Exam |
| | Status (0—Open, 1—Closed) |
| Exam_{—} | Physical Exam ID-see table exam; Patient ID; |
| observations: | System ID-see table systems; Observation |
| | Type-See table observation_types; |
| | Observation text |

According to another embodiment, the data structure is more generally an organization of information stored on the portable memory for providing better algorithm efficiency such as a queue, a stack, a linked list, a heap, a dictionary, or a tree, or may provide conceptual unity, such as the name and address of an animal owner. The data structure may include redundant information such as lengths of the list or number of nodes in a subtree. According to the embodiment, the data structure has associated algorithms to perform operations, such as search, insert, update, delete, or balance, in order to maintain properties of the data structure. Likewise, the data structure may be a database or other organized body of related information.

According to some embodiments, a portable memory interacts with a PIMS on a computer that is coupled with the portable memory. In that case, the data structure of the veterinary records on the portable memory may be configured to parallel the data structure of the PIMS. Thus, the data structure may be a proprietary data structure.

As an example of a PIMS, Cornerstone 5.0 Practice Management System by IDEXX Laboratories provides veterinary practitioners with instant access to frequently-used patient and practice data such as veterinary pharmacy references. Cornerstone also provides integrated links to diagnostic test results and other pertinent medical information. Some or all of this functionality may be provided either within the data structure or within other aspects of the portable memory. Other PIMS are available. The portable memory may be configured to interact with one or more of the given PIMS. Likewise, it is contemplated that an embodiment of the portable memory may be used without connecting with any outside PIMS. In that case, all data and program information may be stored on the portable memory. Alternatively, the portable memory may trigger a computing device to retain certain aspects of data or program code.

The portable memory may include replicated data that is stored in at least two different data structures. For example, one set of data may be stored in a data structure that is compatible with a given PIMS, while another set of data may be stored in a data structure that is compatible with a more generic data management tool, and yet another set of data may be stored in a data structure that is compatible with firmware (such as record management logic) that is stored on the portable memory.

8. Exemplary Operation

a. Overview of Operation

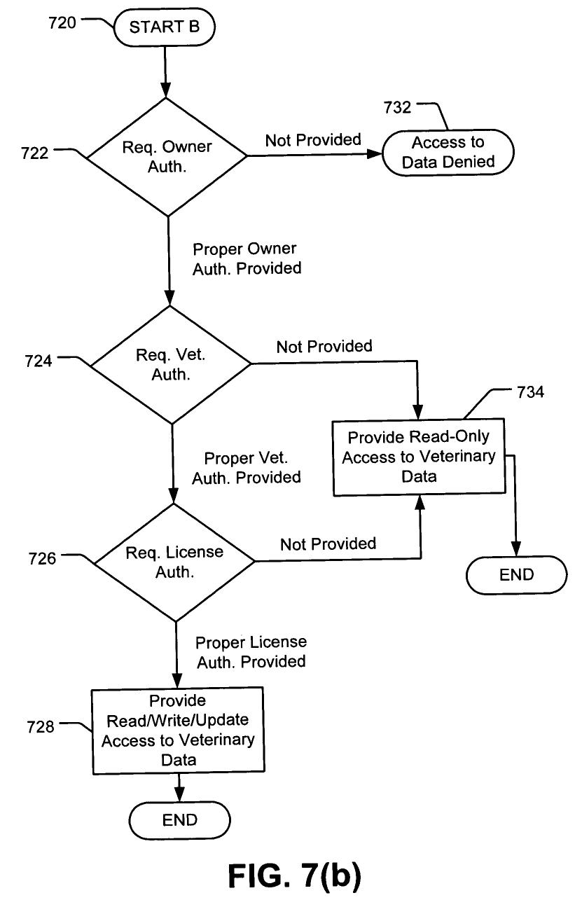

FIGS. 7(a) and 7(b) provides an exemplary process flow for providing access to veterinary data stored in a portable veterinary medical record device. According to the process, the portable veterinary device is coupled with a computer at step 704. The coupling may, for example, be through a serial connection or other connection.

According to the exemplary embodiment, coupling of the two elements serves as a trigger for further steps in the process. For example, coupling may trigger scripting of an autorun.inf file stored on the portable veterinary device. Other triggering methods are available as well.

At step 706, a processor on the computer makes a determination of whether the computer has pre-installed software for managing records on the portable veterinary device and the computer. A set of instructions for making this determination are stored on the portable veterinary device. In addition, another set of instructions for making the determination may be stored on the computer as, for example, part of an installed patient information management system (PIMS).

According to an embodiment, determining whether the computer has a given pre-installed software involves searching a registry on the computer. Other methods for making the determination are available.

If it is determined at step 706 that the computer is “prepared” (with record management software), then the process flows to step 716 and FIG. 7(b).

If it is determined at step 706 that the computer is not prepared, then the process flow moves to step 708 which calls for execution of an authorization procedure that is stored on the portable veterinary device. The authorization procedure is configured to ensure proper user authorization prior to allowing access to veterinary records on the portable veterinary device.

As part of the authorization procedure, owner authorization is requested at step 710. Owner authorization may be any of a PIN number keyed into a user input on the computer, an authorization card coupled with the portable veterinary device (or coupled with the computer), a voice recognition, an ID card scan (such as a credit card or government issued identification card), a retina scan, or a finger print scan. Combinations of the various types of authorization may also be required. For example, in one embodiment, both a PIN and an authorization card are required for proper authentication. In another embodiment, presentation of the portable veterinary device itself provides an owner authorization. One skilled in the art will recognize that other forms of owner authorization are available.

According to this embodiment of a process flow, if proper owner authorization is not provided then access to veterinary records or other data is denied at step 718. If, however, proper owner authorization is found, then the portable veterinary device is configured to allow read-only access to veterinary records or other data that are stored on the device at step 712. According to the exemplary embodiment, read-only access is provided through record-management instructions that are stored on the portable veterinary device as, for example, firmware. According to one embodiment, the record-management instructions provide a program package (such as an applet) that executed through a browser (such as Microsoft Internet Explorer or Netscape Navigator). Program instructions for the browser are preferably preconfigured on the computer.

In the process shown, the authorization procedure is only configured to determine whether or not to grant read-only access to an animal owner. Other levels of authorization are available. For example, access to certain data may require veterinary authorization, software license authorization, or some combination of authorizations. For example, in one embodiment a veterinarian may have certain notes stored on the device that can be inaccessible without veterinarian authorization.

In addition, the level of authorization may vary according to whether read-only access or read/write access is requested. Thus, for example, read-only access may require only one form of user authorization, while read/write access may require two or more forms of user authorization. One skilled in the art will recognize that other user authorization schemes are available and may be implemented for user authorization in the presently described or other systems.

If it was determined that the computer was not pre-configured with proper record management software at step 706, the process flow moved to step 716 and on to step 720 of FIG. 7(b). The pathway shown in FIG. 7(a) is not, however, the only pathway for arriving at step 720.

According to the exemplary embodiment, a set of authorization instructions stored on the portable veterinary device and are executed by the computer at step 720. In the process flow of FIG. 7(b), owner authorization is requested at step 722. If proper owner authorization is not provided then access to data is denied at step 732.

After receiving proper owner authorization, the authorization instructions then call for requesting veterinary authorization at step 724. As one skilled in the art will recognize, the various types of owner authorizations available are equally applicable as veterinary authorizations. If proper veterinary authorization is not provided then read-only access may still be allowed for the veterinary records and data at step 734. Because the PIMS is installed on the computer, data access may be provided through PIMS built-in functionality. Alternatively, data access may be provided by record-management instructions stored on the portable veterinary device.

If proper veterinary authorization is received at step 724, the authorization instructions may call for software licensing authorization at step 726. Software licensing authorization may, for example, be provided by entering a product identification code or by checking a license code of the installed PIMS. In another embodiment use-tickets may be purchased—each use ticket having an authorization code. The use-tickets may allow a “pay as you go” system.

According to the process flow of FIG. 7(a), if proper software licensing authorization is not provided, read-only access may still be granted at step 734. If, however, proper license authorization is provided then the system may be configured to provide full access (such as read/write/update access) to the veterinary records or other data stored on the portable veterinary device.

The authorizations (owner, veterinary, and license) requested in steps 722-726 are shown in a specific order. However, one skilled in the art will recognize that such authorizations may be provided in any order or may be substantially simultaneous. In addition, the specific results of proper/improper user authorization are not necessarily as shown. For example, in an embodiment, certain data may be updated by an owner without veterinary authorization. In addition, the need for software license authorization is eliminated in certain embodiments.

b. Record Update

In another embodiment, when the portable veterinary record device is coupled with a computer with an installed PIMS, the computer (or a set of instructions on the device) is configured to recognize the device and check for record updates on either the PIMS or on the portable device. If either set of records have been updated since the last synchronization, then another synchronization is performed to ensure that two copies of the veterinary medical records are up-to-date. Thus, only single data entry is required. In addition, an owner who takes an animal to more than one veterinary office can carry medical records between the offices on the device.

c. Operation when Owner's PIN is Unavailable

According to an embodiment, when a PIN is forgotten, or when an owner is unable to provide it (such as when unconscious), provision could be made for identified professionals to “break in” for emergency.

During initial setup or at other times, the owner may specific whether to allow emergency access or may specify the level of emergency access. According to one example, if the owner's PIN is unavailable a DVM may be allowed access after, for example, providing a DVM ID. Alternatively, a self-authentication may simply request a user to affirmatively answer a prompt or license display.

Thus, authentication standards may be relaxed during an emergency situation in order to provide proper care for the patient.

d. Operation when the Device is Removed

According to one embodiment the portable memory element may be physically removed with specifically informing the attached computer prior to action. Such random removal has the potential to leave the memory element in a corrupted state. Thus, to mitigate the likelihood of data loss in a surprise removal scenario, an embodiment provides for a refined caching policy. In the refined caching policy, changes to files are saved as they are made. This keeps data on the removable memory element more current, thus mitigating the likelihood of data loss. However, this write caching policy may have a negative performance impact.

9. Conclusions

Various embodiment of the present invention have been described above. Those skilled in the art will understand, however, that changes and modifications may be made to these embodiments without departing from the true scope of the present invention, which is defined by the claims. For example, other data security means could be used rather than hard-coded authentication. These means could include encryption with a password release or multi-level encryption that may require multiple keys to release certain aspects of the data. Although applicability of the embodiments were described primarily with reference to veterinary practice, it is contemplated that other embodiments may be used to store and secure human medical records or hospital records. Further, many of the elements described herein are functional entities that may be implemented as hardware, firmware or software, and as discrete components or in conjunction with other components, in any suitable combination and location.

We claim:

1. A portable veterinary medical record apparatus comprising:
a nonvolatile re-writable memory array;
a data structure organized on the re-writable memory array for storing veterinary records;
a first set of machine readable instructions stored on the re-writable memory for providing user authentication;
a second set of machine readable instructions stored on the re-writable memory fro providing access to the data structure;
a read-only memory array;
a set of authentication values stored on the read-only memory array, wherein the first set of machine readable instructions are configured to request use of the authentication values as keys for ensuring proper authentication; and
a data port for communicatively coupling the memory arrays with a computing device.

2. The portable veterinary medical record apparatus of claim 1, further comprising:
a portable storage device comprising:
the nonvolatile re-writable memory array;
the data structure;
the first set of machine readable instructions;
the data port; and
an authentication port;
a portable authentication module comprising:
the read-only memory;
at least one authentication value from the set of authentication values; and
an authentication port, wherein the authentication port of the portable storage device is configured to communicatively couple with the authentication port of the portable authentication module, and
wherein proper authentication requires that the authentication port of the portable storage device be communicatively coupled with the authentication port of the portable authentication module.

3. The portable veterinary medical record apparatus of claim 1, wherein the nonvolatile re-writable memory array is a flash memory;

4. The portable veterinary medical record apparatus of claim 1, wherein the data port is a serial data port.

5. The portable veterinary medical record apparatus of claim 1, wherein the first set of machine readable instructions provides for an architecture neutral interaction with the coupled computing device.

6. The portable veterinary medical record apparatus of claim 1, wherein the proper authentication comprises at least two security levels,
a first security level having read-only data access, wherein proper authentication at the first security level requires identification of at least one of an owner and a veterinarian, and
a second security level having read and write data access, wherein proper authentication at the second security level requires identification of at least the owner and the veterinarian.

7. The portable veterinary medical record apparatus of claim 1, wherein veterinary records stored in the data structure are encrypted to prevent unauthorized access.

8. The portable veterinary medical record device of claim 1, wherein the first set of machine readable instructions is configured to allow read-access to the veterinary records only after on of an authenticated veterinarian key and an authenticated owner key is provided at an input of the computing device.

9. The portable veterinary medical record device of claim 8, wherein the first set of machine readable instructions is further configured to allow write-access and update-access to the veterinary records only after all three of the authenticated veterinarian key, the authenticated owner key, and an authenticated license key are provided at the computing device.

10. The portable veterinary medical record apparatus of claim 1, wherein apparatus is configured to automatically enable the computing device to determine whether patient management software is installed on the computing device, and depending upon the determination, being operable in one of two alternate modes.

11. The portable veterinary medical record apparatus of claim 10, wherein the two alternate modes comprise:
an external management mode for providing access to the veterinary records through the patient management software; and
an internal management mode for providing access to the veterinary records through firmware stored on the re-writable memory array.

12. The portable veterinary medical record apparatus of claim 11, wherein the data structure contains replicated data,
wherein a first includes a database file configured to interoperate with the patient management software; and
wherein a second replica is configured to interoperate with the firmware stored on the re-writable memory array.

13. The portable veterinary medical record apparatus of claim 1, wherein proper authentication may be provided at least in part by a key device that is associated with a veterinary office.

14. A method of accessing a medical record at a computing device comprising:
executing a first set of machine language instructions stored on a portable memory, wherein executing the first set of machine language instructions is triggered by communicatively coupling the portable memory and the computing device, and wherein the first set of machine language instructions is configured to enable the computing device to determine whether a given software is installed on the computing device;
determining that the given software is not installed on the computing device; and
executing a second set of machine language instructions stored on the portable memory, wherein the second set of machine language instructions is configured to enable the computing device to provide access to veterinary medical records stored on the portable memory.

15. The method of accessing a medical record of claim 14, wherein the second set of machine language instructions comprise:
a set of machine language user authentication instructions, wherein the set of machine language user authentication instructions is configured to enable the computing device to ensure proper user authorization; and
a set of machine language data access instructions, wherein the set of machine language data access instructions is configured to enable the computing device to access the veterinary medical records stored on the portable memory, wherein the veterinary medical records stored on the portable memory are inaccessible without proper user authentication.

16. The method of accessing a medical record of claim 15, further comprising a set of user authorization values stored as read-only data on the portable memory, wherein the set of machine language user authentication instructions is configured to enable the computing device to query the user authorization values for ensuring proper user authorization.

17. The method of accessing a medical record of claim 14, wherein executing a second set of machine language instructions stored on the portable memory comprises:
requesting owner authentication;
requesting veterinary authorization;
based in part on the results of the authorization requests, accessing a medical record stored on the portable memory.

18. The method of accessing a medical record of claim 17, wherein requesting owner authentication comprises:
requesting an owner PIN at a user input of the computing device.

19. The method of accessing a medical record of claim 17, wherein requesting owner authentication comprises:
determining whether an owner authentication card has been coupled with the portable memory.

20. A portable veterinary medical record apparatus comprising:
a nonvolatile re-writable memory array;
a data structure organized on the re-writable memory array for storing veterinary records;
a data port for communicatively coupling with a computing device;
a first firmware configured for automatic execution by the computing device; and
a second firmware for providing access to the veterinary records,
wherein the first firmware enables the computing device 1) to determine whether a patient management software is installed on the computing device, and, if the patient management software is determined to not be installed, 2) to execute the second firmware.

21. A portable medical record apparatus comprising:
a portable record-holder comprising:
a re-writable memory for storing medical records;
a firm-ware authentication protocol;
a data port for coupling with a computing device; and
two authentication ports;
a veterinary authentication card comprising:
a veterinary authentication code stored in read-only memory; and
an authentication port, wherein the authentication port of the veterinary authentication card is configured to couple with one of the authentication ports of the portable record-holder; and
an owner authentication card comprising:
an owner authentication code stored in read-only memory; and
an authentication port, wherein the authentication port of the owner authentication card is configured to couple with one of the authentication ports of the portable record-holder.
